(19) United States
(12) Patent Application Publication
(10) Pub. No.: US 2021/0252522 A1
(43) Pub. Date: Aug. 19, 2021

(54) INSTALLATION FOR EXTRACTING HEAT AND/OR FOR PROCESSING PROCESS LIQUID

(71) Applicant: EWK Umwelttechnik GmbH, Kaiserslautern (DE)

(72) Inventor: Peter Ohlenschlaeger, Kaiserslautern (DE)

(21) Appl. No.: 17/172,462

(22) Filed: Feb. 10, 2021

(30) Foreign Application Priority Data
Feb. 18, 2020 (DE) 10 2020 104 155.1

(51) Int. Cl. B02C 23/18; F28F 19/01; B01D 21/24; B01D 21/00; C02F 9/00

(52) U.S. Cl. CPC B02C 23/18; F28F 19/01; B01D 21/2455; C02F 1/004; B01D 21/0027; C02F 9/00; B01D 21/0012; B01D 21/0042

(57) ABSTRACT

The disclosure relates to an installation for processing and/or using process liquid, comprising at least one first installation section which comprises at least one heat exchanger for heating the process liquid. The heated process liquid can be guided directly or indirectly to a second installation section for processing and/or use. The invention is directed to the problem of providing an installation by means of which the wear and tear of comminution mechanisms, in particular for frozen, cold or tough biomass, can be reduced in a cost-effective and environmentally friendly manner. The installation is characterized in that the second installation section comprises at least one washing, soaking and/or thawing booth device for treating biomass using the warm process liquid.

### CROSS-REFERENCE TO RELATED APPLICATION(S)

This application claims priority under 35 U.S.C. § 119 to: German Patent Application No.: 10 2020 104 155.1, filed on 18 Feb. 2020, which is herein incorporated by reference.

### TECHNICAL FIELD

The present disclosure relates to the treatment of biomass using a process liquid.

### BACKGROUND

Biomass or organic material is often fed to an installation section in frozen or very rigid and cold form. In this installation section, the biomass is comminuted, in particular cut, chopped or sawn. Due to the hardness or the toughness of the frozen or very cold biomass, comminution mechanisms such as knives, prongs or saws become heavily worn and are subject to high levels of wear and tear.

The problem addressed by the disclosure is therefore that of providing an installation by means of which the wear and tear of comminution mechanisms, in particular for frozen, cold or tough biomass, can be reduced in a cost-effective and environmentally friendly manner.

The present disclosure addresses this problem as more fully described below.

### SUMMARY

In accordance with the disclosure, an installation is provided for processing and/or using process liquid. The installation includes at least one first installation section which has at least one heat exchanger for heating the process liquid. The heated process liquid is guided directly or indirectly to a second installation section for processing and/or use. The second installation section includes at least one washing, soaking and/or thawing apparatus for treating biomass using the warm process liquid.

### BRIEF DESCRIPTION OF THE DRAWINGS

The features, aspects, and advantages of the present disclosure will become better understood with regard to the following description, appended claims, and accompanying drawings where:

FIG. 1 shows an installation comprising a plurality of installation sections which interact with one another at interfaces, a process liquid being heated by a heat exchanger in a first installation section, the process liquid then being used to thaw and/or clean frozen biomass, and the process liquid, which is contaminated after thawing, then being subjected to a three-stage cleaning process;

FIG. 2 shows the first installation section comprising heat exchangers and a second installation section in which the biomass, in particular wood, is treated using the heated process liquid;

FIG. 3 shows a third installation section which has a coarse material separator which is designed as a hooked step screen;

FIG. 4 is a further view of the coarse material separator according to FIG. 3 which is designed as a hooked step screen;

FIG. 5 is a fourth installation section, which comprises at least one oval wheel separator;

FIG. 6 is a detailed view of the oval wheel separator according to FIG. 5;

FIG. 7 is a detailed view of two oval wheels which interact with one another;

FIG. 8 shows schematically the operating principle of the oval wheel separator;

FIG. 9 shows a fifth installation section comprising a flotation device which comprises a flotation tank for receiving process liquid to be cleaned and a saturator for receiving a pressurized liquid-gas mixture, a pipe leading from the saturator to at least one feeder, through which pipe the pressurized liquid-gas mixture can be introduced into the flotation tank, the feeder having a flow channel which has different flow cross-sectional areas along its extension, and the feeder having a Venturi nozzle or being designed as such; and

FIG. 10 is a detailed view of the flotation device according to FIG. 9.

### DETAILED DESCRIPTION OF ILLUSTRATIVE EMBODIMENTS

According to the disclosure, it was first recognized that a warm process liquid can be used to soak, thaw or heat biomass or organic material. It was then recognized that the process liquid can be heated by means of a heat exchanger, the heat exchanger drawing the heat given off to the process liquid from an exhaust air purification process or another method, in particular a method for treating exhaust gas. Existing waste heat can be used inexpensively and in an environmentally friendly manner to thaw, soak or heat biomass using warm process liquid. As a result, comminution mechanisms are protected and can be used for a longer service life because the biomass to be comminuted is softened and the comminution mechanisms are less heavily worn. According to the disclosure, the second installation section comprises at least one washing, soaking and thawing booth device for treating biomass, in particular logs. In this device, the warm process liquid can be used to thaw wood and/or to remove bark or other contaminants. Of course, it is also conceivable to use sugar beets or corncobs as the biomass.

The washing, soaking and/or thawing booth device could have a nozzle for atomizing or distributing the process liquid. In this way, biomass can be soaked or wetted well using process liquid. Alternatively or in addition, the first installation section could be part of a device for treating exhaust gas. The waste heat that is introduced into a scrubbing liquid during gas scrubbing can be used to heat the process liquid.

A third installation section could be provided which comprises a coarse material separator which is designed as a hooked step screen. By using a coarse material separator of this kind, no material is returned, and continuous operation and a low-wear chain drive can be achieved.

The coarse material separator could be arranged in a drainage channel. Liquid can be reliably retained and/or stored in a drainage channel of this kind.

A fourth installation section could comprise an oval wheel separator which has rotating plates by means of which solid-liquid mixtures can be transported and/or the liquid can be at least partially removed from said solid-liquid mixtures. As a result, fine material is not separated using a so-called lamella clarifier, but instead using at least one oval wheel separator. An oval wheel separator operates in a stable manner and does not tend to block. An oval wheel separator achieves higher throughputs and better removal of the liquid than a lamella clarifier. In addition, the oval wheel separator saves energy and is self-cleaning, and therefore no backwashing is necessary. An installation of this kind is low-wear and low-maintenance.

The aforementioned plates could be arranged on a rotating shaft and pass through a static lattice when rotating. As a result, a large number of plates, i.e. far more than three or four plates, can pass through the parallel beams of the lattice like prongs and transport the solid-liquid mixture.

The rotatable plates could be non-circular and/or oval and/or elliptical. As a result, the non-circular edges of the plates which pass through the lattice subject the solid-liquid mixture to a kind of undulating motion or a kind of fluctuating motion.

A fifth installation section can be provided which comprises a flotation device. In this way, the finest material and suspended matter can be separated by means of a pressure-release flotation process. A flotation device could be used as described in the applicant's German patent application DE 10 2018 128 951.0.

In one method, an installation of the type described here could be used and a warm process liquid could be used for thawing or soaking frozen or cold biomass, the process liquid having been heated or being heated by at least one heat exchanger using waste heat from exhaust gas treatment. This results in a cost-effective and environmentally friendly use of heat or waste heat.

Against this background, the process liquid could be fed to a hooked step coarse material screen in a first stage, be fed to a fine material oval wheel separator in a second stage, and be subjected to a pressure-release flotation process in a third stage. In this way, suspended particles and contaminants can gradually be removed from the process liquid. Coarser particles are removed, then finer particles and finally the finest particles. Before being fed to the first stage, the process liquid has preferably been used to thaw, soak or remove contaminants from biomass or wood.

No decanters, no sludge pumps and no sludge storage tank are necessary.

Furthermore, NaOH dosing is not required. In addition, it is not necessary to dose any biocides and only a limited use of defoamers is required, if any. Finally, no water softening is required. In the installation described here, there is preferably a redundant design of pumps, coarse material separation and fine material separation. No back-up pumps are used.

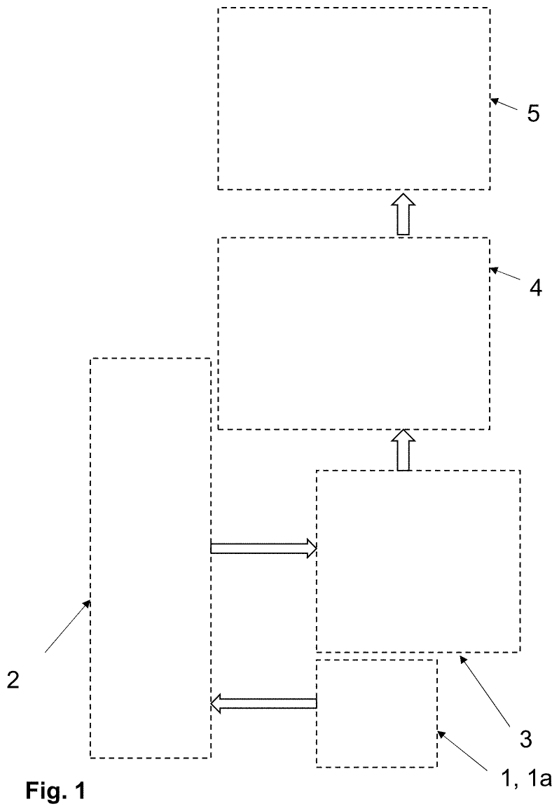

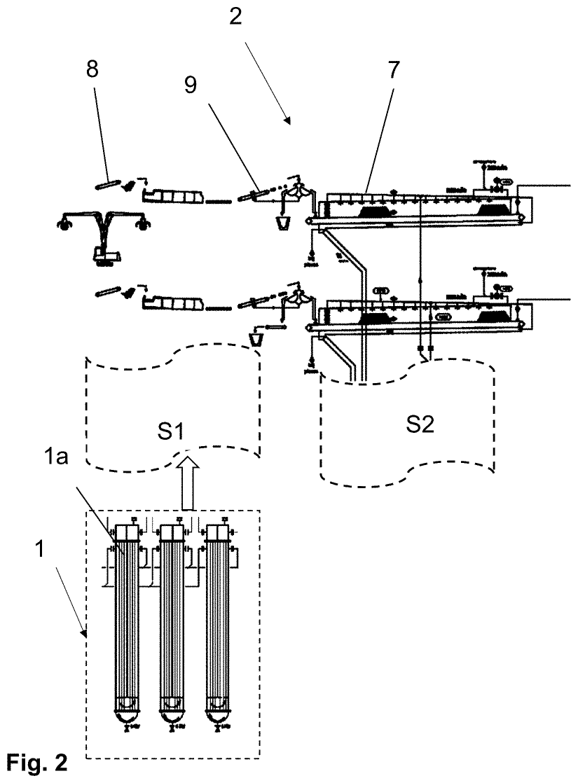

FIG. 1 shows an installation comprising a plurality of installation sections 1, 2, 3, 4, 5, to which individual devices or arrangements are assigned, the installation sections 1, 2, 3, 4, 5 interacting with one another at interfaces S1 to S4, as shown in FIGS. 2, 3, 5 and 6.

FIG. 1 shows specifically an installation for processing and/or using process liquid, comprising at least one first installation section 1 which comprises at least one heat exchanger 1a for heating the process liquid, it being possible to guide the heated process liquid directly or indirectly to a second installation section 2 for processing and/or use. The first installation section 1 is part of a device for treating exhaust gas.

The second installation section 2 comprises at least one washing, soaking and/or thawing booth device 7 for treating biomass using the warm process liquid. The washing, soaking and/or thawing booth device 7 has a nozzle 6 for atomizing and distributing the process liquid.

FIG. 2 shows, on the basis of the second installation section 2, that in particular debarked logs 8, but also other wood or other biomass, are fed via conveyor belts 9 to one or more washing, soaking and/or thawing booth devices 7, so-called ice channels. The logs 8 can also be frozen. In the washing, soaking and/or thawing booth devices 7, the logs 8, or optionally wood or other biomass, are sprayed from above with warm process liquid, specifically preferably with warm circulating water, in order to rinse off particles and to simultaneously thaw and soak the logs 8. As a result, further machine processing of the logs 8 is optimized and the service life of machines, in particular of comminution machines, is extended.

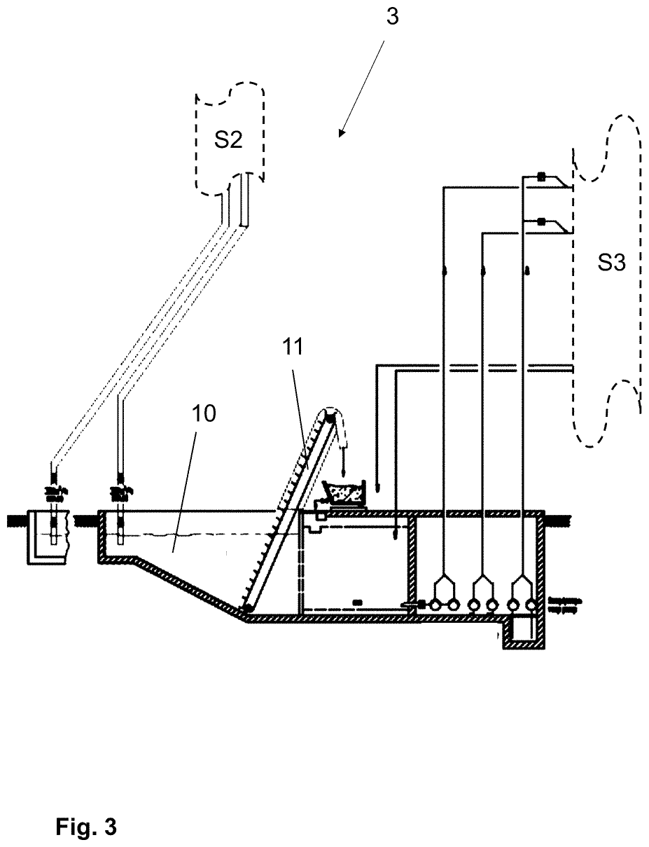

FIG. 3 shows, with reference to a third installation section 3, that the process liquid that has been contaminated from the washing, soaking and/or thawing booth devices 7 is fed via the interface S2 to a drainage channel 10 which is preferably part of a concrete drainage system. A plurality of drainage channels 10 can be provided. In a drainage channel 10 there is at least one coarse material separator 11 which is designed as a hooked step screen.

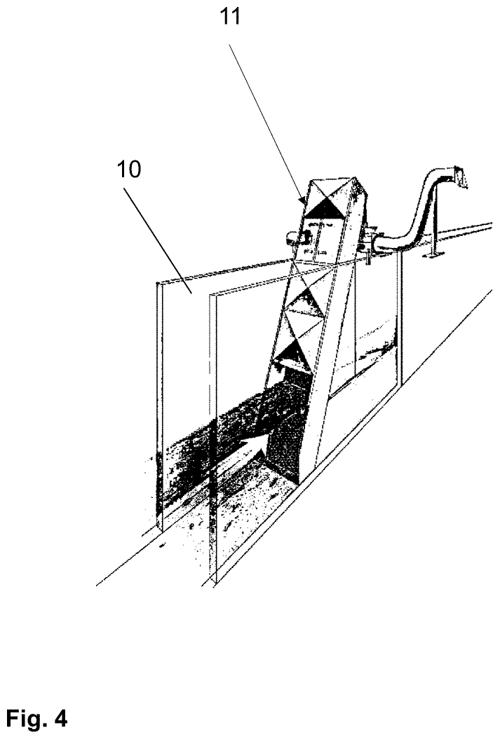

FIG. 4 shows, in a perspective view, the coarse material separator 11 which is designed as a hooked step screen. The third installation section 3 therefore comprises at least one coarse material separator 11 which is designed as a hooked step screen. The coarse material separator 11 is arranged in the drainage channel 10. A hooked step screen has an easy-to-understand working principle and has a simple design. A self-cleaning effect occurs according to the countercurrent principle. The coarse material separator 11 is easy to maintain, can discharge very large amounts of screened material, has a high level of operational reliability, has a coupling mechanism, and is user-friendly.

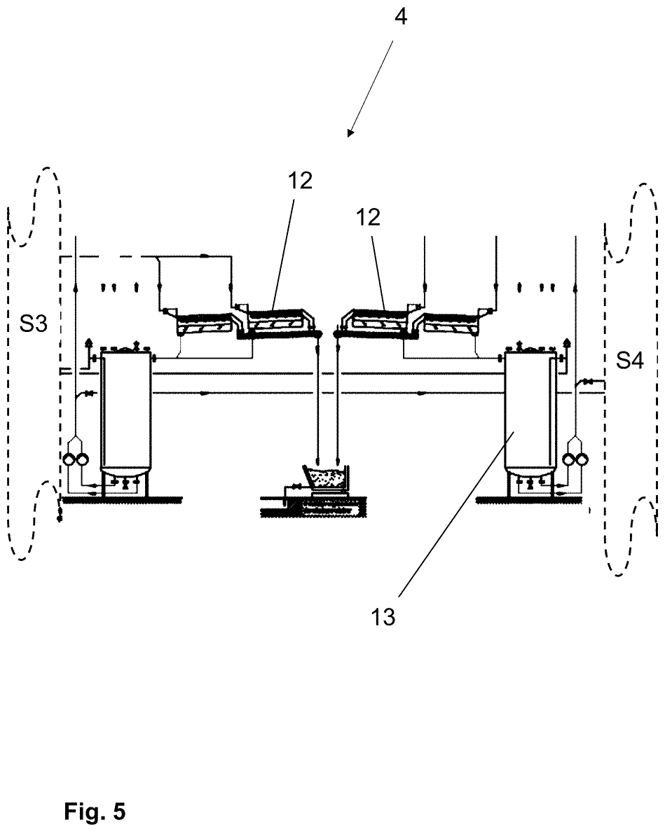

FIG. 5 shows, with reference to the fourth installation section 4, that the process liquid that has been pre-cleaned by the coarse material separator 11 is fed to one or more oval wheel separators 12 via pumps upstream or downstream of the interface S3, which separator(s) ensure(s) that fine material, the average particle size of which is less than 1.5 mm, is separated. Flocculants can also be added to improve the separation efficiency. The process liquid is then collected in a pump reservoir 13, specifically a filtrate container. The pump reservoir 13 acts as a collection container, but also has the task of keeping appropriate volumes available when an installation is started up. The cleaned process liquid is fed to the heat exchangers 1a by means of quench pumps, is heated and then atomized in the washing, soaking and/or thawing booth devices 7 of the second installation section 2.

FIG. 5 specifically shows that the fourth installation section 4 comprises at least one oval wheel separator 12 which has rotating plates 14 by means of which solid-liquid mixtures can be transported and/or the liquid can be at least partially removed from said solid-liquid mixtures. The plates 14 are arranged on a rotating shaft 15 and pass through a static lattice 16 when rotating. The rotatable plates 14 are non-circular and/or oval and/or elliptical.

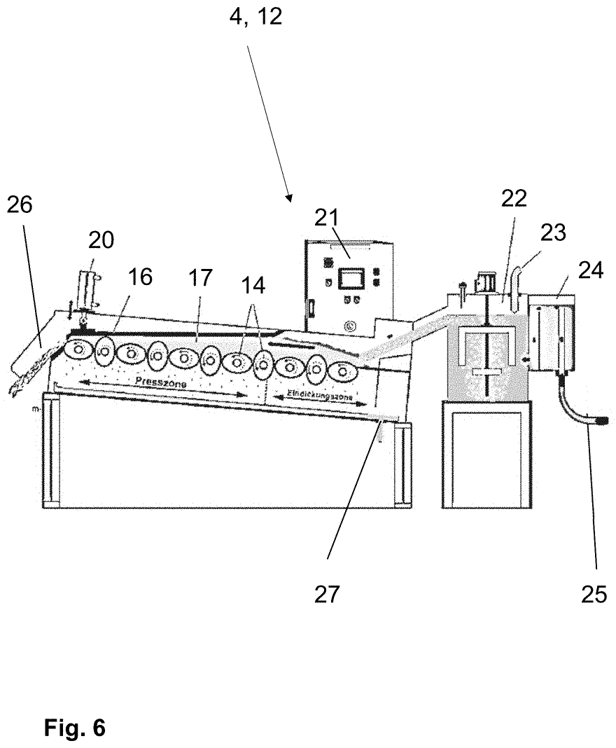

FIG. 6 shows, in more detail, the core piece of the fourth installation section 4, specifically the oval wheel separator 12, which has a row of parallel, slowly rotating shafts 15, to each of which a plurality of oval plates 14 are attached, such that altogether a large number of oval plates 14 rotate. FIG. 6 shows that the oval wheel separator 12 has a pneumatic cylinder, a control cabinet 21 and a flocculation tank 22. An inlet 23 for a polymer coagulate leads into the flocculation tank 22. Furthermore, a sludge inlet container 24, a sludge inlet 25 and a sludge discharge 26 are provided. Finally, a filtrate outlet 27 is provided.

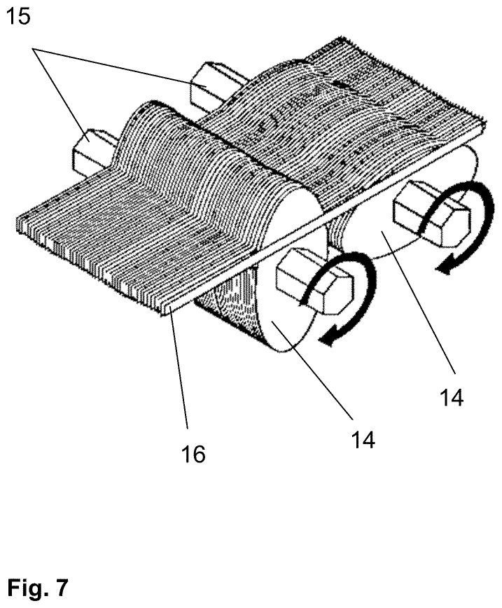

FIG. 7 specifically shows that the plates 14 pass through the static lattice 16 when rotating. The rotating plates 14 thus transport solid waste and sludge flocs on the lattice 16, while a liquid phase can flow off through the static lattice 16.

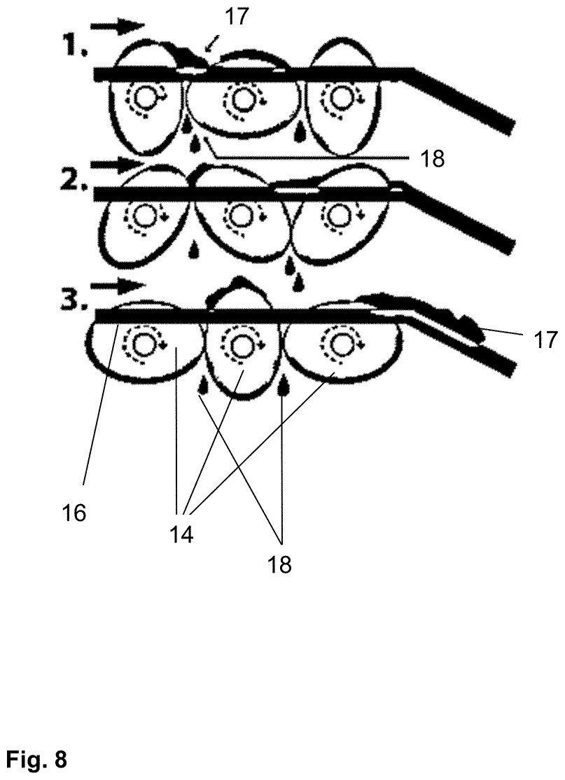

FIG. 8 shows particularly clearly that the oval or elliptical shape of the plates 14 altogether causes an undulating motion to which solid waste 17 is subjected. As a result, solid waste 17 or sludge is well drained, the plates 14 clean themselves, and liquid 18 can flow off downward. A gap width of preferably 1 mm is maintained between the plates 14 in order to ensure that the solid waste 17 or sludge to be removed is reliably thickened and to prevent clogging. Two plates 14 that are consecutive in the sludge movement direction rotate in the same direction at a substantially constant gap clearance. The elliptical shape of the plates 14 results in a transport movement in the direction of the arrows in FIG. 8. The numbers 1, 2, 3 in FIG. 8 show the sludge movement over time after the plates 14 have rotated 45°.

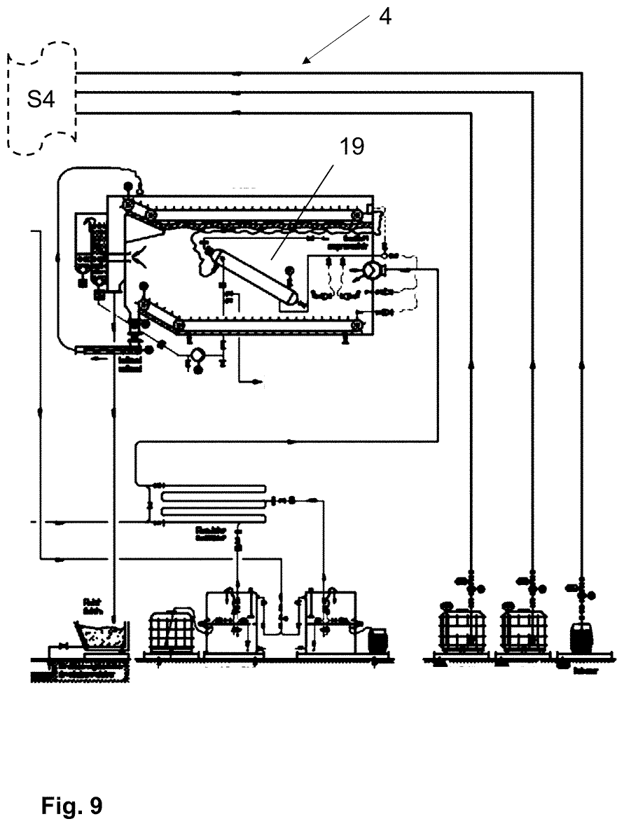

FIG. 9 shows that a flotation device 19, specifically a pressure-release flotation device, is integrated in a bypass to avoid saturation of the process liquid by fibers, suspended matter and similar substances. The operating principle of a flotation device or the specific flotation device 19 is described in the applicant's German patent application DE 10 2018 128 951.0. Before the process liquid enters the flotation device 19, prepared coagulant and flocculant are dosed in a tube flocculator. The dosing is volume-dependent, based on the total solid material.

To ensure the functionality of the installation or the process liquid system, especially in the event of a shutdown, power failure or other accidents, the process liquid flows from the washing, soaking and/or thawing booth devices 7 completely to and from a process liquid building. Concrete tanks attached to the drainage channels 10 receive excess process liquid and can automatically feed said process fluid back into the process liquid circuit by means of integrated backwater valves when the installation is started up. To provide frost protection, the heat exchangers 1a are also automatically emptied on the process liquid-side in the event of an accident. A control system of the installation comprises on-site visualization, is designed to be fully automatic, and is preferably arranged in the process liquid building. By using the waste heat of the process liquid, the process is CO2-neutral and up to 30 MW per hour can readily be used for a production process or for processing biomass at no extra cost.

The process liquid preferably consists predominantly of water. The installation for processing the process liquid uses substantially the following technical processes and/or components: introducing heat from waste heat during exhaust gas cleaning; a glycol-water/process water heat exchanger; returning process water in conjunction with coarse material separation; processing process water in conjunction with fine material separation; and separating fine particle and suspended matter by means of a pressure-relaxation flotation process.

One or more heat exchangers 1a, preferably water-glycol/process water heat exchangers, can be provided in the process liquid circuit, which heat exchangers can preferably be fed by an exhaust gas cleaning installation.

Heated process liquid is atomized by means of a pipeline system in the washing, soaking and/or thawing booth devices 7 and flows to where the preparation for fine, coarse and floating sludge takes place, which is preferably housed in a separate building.

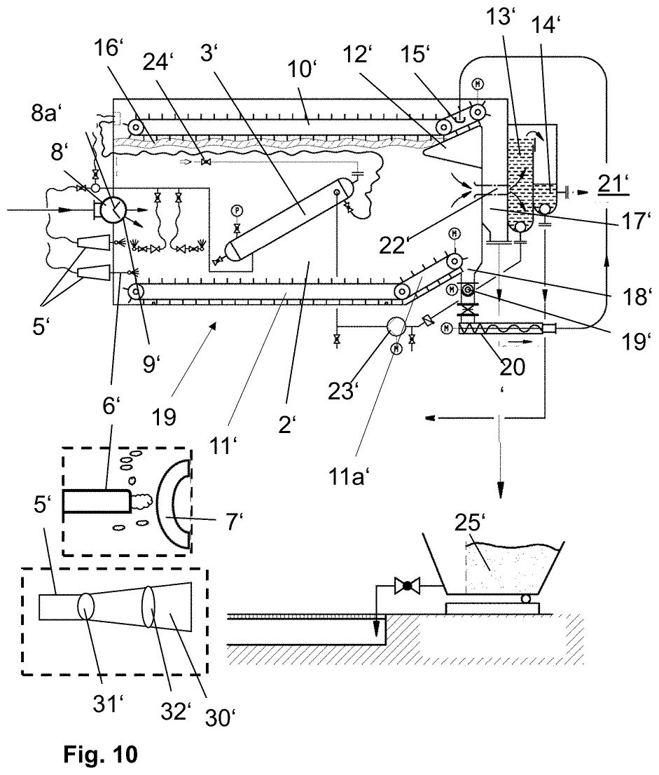

FIG. 10 shows the flotation device 19, which has already been described in DE 10 2018 128 951.0, comprising a flotation tank 2′ for receiving process liquid to be cleaned and a saturator 3′ for receiving a pressurized liquid-gas mixture, a pipe, specifically a distribution pipe, leading from the saturator 3′ to at least one feeder 5′, through which pipe the pressurized liquid-gas mixture can be introduced into the flotation tank 2′. The feeder 5′ or all the feeders 5′ has/have a flow channel 30′ which has different flow cross-sectional areas 31′, 32′ along its extension. The feeder 5′ or each feeder 5′ has a Venturi nozzle or is designed as such. This is shown schematically at the bottom left-hand side in FIG. 10. The above-mentioned pipe extends at least in regions around the flotation tank 2′, the pipe opening into a plurality of feeders 5′ without the interposition of a valve, which feeders are spaced apart from one another on or in the outer wall of the flotation tank 2′.

FIG. 10 shows, in particular in the middle, detailed view shown in broken lines, that the feeder 5′ opens into an injector lance 6′ which protrudes into the interior of the flotation tank 2′, a convex baffle plate 7′, specifically an impact distributor, being assigned to the end of the injector lance 6′ which protrudes into the interior. The convex face of the baffle plate 7′ faces the end of the injector lance 6′. A plurality of injector lances 6′ are connected to the feeders 5′ by means of Venturi nozzles. Specifically, no valve is provided which limits the connection between the pipe and the interior of the flotation tank 2′. A person skilled in the art would expect that feeding the pressurized liquid from the pipe into the flotation tank 2′ would lead to an immediate drop in pressure. As a result, the process liquid flowing into the flotation tank 2′ would almost no longer be pressurized, and therefore it would not be possible to effectively outgas atmospheric oxygen. By providing the Venturi nozzles, the pressure in the pipe is maintained substantially constant, and therefore the pressurized process liquid can be introduced into the flotation tank 2′ all around and under pressure.

The pressurized process liquid, which relieves pressure inside the flotation tank 2′, causes a microbubble effect which carries particles to the surface of the liquid in the flotation tank 2′. A foam, specifically the flotate 16′, in which particles accumulates, forms on the surface of the liquid. The saturator 3′ is designed as a pressure vessel which, in the example specifically shown, is arranged on the outside of the flotation tank 2′.

FIG. 10 further shows that an inlet distributor 8′ is provided for introducing process liquid to be cleaned into the flotation tank 2′, the inlet distributor 8′ extending at least partially along an outer wall of the flotation tank 2′ and being provided with slots 9′. The inlet distributor 8′ is integrated into the outer wall. FIG. 10 shows that a distributor structure 8a′ is provided within the inlet distributor 8′ in order to distribute process liquid, which flows in from the left-hand side in the plane of the drawing, over the length of the inlet distributor 8′. The slots 9′ are longitudinal slots which are arranged such that the process liquid to be cleaned can be injected or introduced into the flotation tank 2′ at an angle of 5 to 50° inclined in relation to the horizontal. By homogeneously introducing the process liquid to be cleaned, the liquid already in the container is mixed.

A flotate clearer 10′ is arranged in an upper region of the flotation tank 2′. A sediment clearer 11′ is arranged in a lower region of the flotation tank 2′. The flotate clearer 10′ is a kind of upper conveyor belt. The flotate clearer 10′ has scrapers which sweep over the surface of the liquid and feed the flotate 16′ to an inclined upper ramp 12′. The upper ramp 12′ is designed to be long enough that flotate 16′ located on the ramp 12′ can be drained. The upper inclined ramp 12′ connects to the flotate clearer 10′ at a length of 50 to 80 cm, onto which ramp the flotate 16′ can be brought by the flotate scraper 10′. An overflow weir 13′ in the form of a first tank is also provided, into which liquid that has been pre-cleaned, a so-called permeate or a clear phase, can flow before flowing into a second tank 14′.

FIG. 10 further shows that a trough 15′ is provided above the upper ramp 12′, which acts as a sediment distributor. The trough 15′ has slots or holes so that water can flow from the sediment back into the flotation tank 2′.

With reference to FIG. 10, a cleaning method is preferably carried out as follows:

Process liquid, raw water or dirty water flows from the left-hand side in the plane of the drawing into the inlet distributor 8′ and from there flows into the flotation tank 2′ at an angle. A two-substance mixture escapes from the injection lances 6′, microfine gas bubbles are formed and carry particles to the surface of the liquid in the flotation tank 2′. There a flotate 16′ accumulates, which is brought by the flotate clearer 10′ onto the ramp 12′ and from there into a sludge discharge shaft 17′. Beforehand, liquid runs back from the upper ramp 12′ into the flotation tank 2′.

The flotate 16′ from which liquid has been removed is conveyed into the sludge discharge shaft 17′. The flotate is conveyed by the scrapers of the flotation clearer 10′. From the sludge discharge shaft 17′, the flotate 16′ is fed into a drainage container 25′. The sediment clearer 11′, specifically a kind of lower conveyor belt, is located at the bottom of the container. The sediment clearer 11′ clears sediment from the bottom of the flotation tank 2′ and feeds it onto a similarly inclined lower ramp 11a′. The sediment falls from the lower ramp 11a′ into a sediment discharge shaft 18′.

From there, the sediment is transported by a screw conveyor 19′ to a sediment pump 20′ which conveys the sediment via a sediment pipe 21′ into the trough 15′. There the sediment is drained as described above by means of slots in the trough 15′. The liquid runs through the slots in the trough 15′ onto the upper ramp 12′ and from there runs back into the flotation tank 2′. From the trough 15′, which is specifically provided with longitudinal slots, the sediment then also falls into the sludge discharge shaft 17′ and is carried away to the drainage container 25′.

An aqueous clear phase, the so-called permeate, flows out of the flotation tank 2′ via a clear phase outlet 22′ into the overflow weir 13′. From there the permeate can overflow into the second tank 14′. The clear phase can be fed from the second tank 14′ to another installation. However, some of the permeate is brought from the overflow weir 13′ by means of a permeate pump 23′ to the saturator 3′, where pressurized air below 6 bar is applied to the permeate.

The compressed air is introduced into the saturator 3′ from above via a compressed air pipe 24′. At the lower end of the inclined saturator 3′, the pressurized permeate, as described above, is brought into the pipe and from there is brought to the feeders 5′. The flotation device 19 according to FIG. 10 described here is an HPDF (high performance decompression flotation) flotation device.

It is to be understood that the description of the foregoing exemplary embodiment(s) is (are) intended to be only illustrative, rather than exhaustive. Those of ordinary skill will be able to make certain additions, deletions, and/or modifications to the embodiment(s) of the disclosed subject matter without departing from the spirit of the disclosure or its scope.

What is claimed is:

1. An installation for processing and/or using process liquid, comprising at least one first installation section which comprises at least one heat exchanger for heating the process liquid, the heated process liquid being guided directly or indirectly to a second installation section for processing and/or use, wherein the second installation section comprises at least one washing, soaking and/or thawing apparatus for treating biomass using the warm process liquid.

2. The installation according to claim 1, wherein the washing, soaking and/or thawing apparatus has a nozzle for atomizing or distributing the process liquid.

3. The installation according to claim 1, further comprising a third installation section for receiving the process liquid used in the second installation section, the third installation section having a coarse material separator comprising a hooked step screen.

4. The installation according to claim 3, wherein the coarse material separator is arranged in a drainage channel.

5. The installation according to claim 3, further comprising a fourth installation section for receiving the process liquid from the third installation section, the fourth installation section comprising an oval wheel separator which has rotating plates by means of which solid-liquid mixtures can be transported and/or the liquid can be at least partially removed from said solid-liquid mixtures.

6. The installation according to claim 5, wherein the plates are arranged on a rotating shaft and pass through a static lattice when rotating.

7. The installation according to claim 5, wherein the rotatable plates are non-circular and/or oval and/or elliptical.

8. The installation according to claim 5, further comprising a fifth installation section for receiving the process liquid from the fourth installation section, the fifth installation section comprising a flotation device.

9. A method of using the installation of claim 1, comprising using the at least one heat exchanger to heat the process liquid and applying the warm process liquid to thaw or soak frozen or cold biomass, wherein the at least one heat exchanger uses waste heat from an exhaust gas treatment process to heat the process liquid.

10. The method of claim 9, further comprising feeding the process liquid to a hooked step coarse material screen in a first stage, feeding the process liquid to a fine material oval wheel separator in a second stage, and subjecting the process liquid to a pressure-release flotation process in a third stage.

11. The method of claim 9, wherein the cold biomass comprises frozen logs.

12. The installation of claim 1, wherein the first installation section is part of an apparatus for treating exhaust gas.

13. The installation of claim 1, further comprising a coarse separator for removing coarse material entrained in the process liquid during the treatment of the biomass in the second installation section;
a wheel separator for treating the process liquid after material is removed in the coarse separator, the wheel separator removing fine material from the process liquid;
a flotation tank for receiving the process liquid from the wheel separator, the flotation tank having a flotate clearer and injection lances for injecting a pressurized liquid-gas mixture into the flotation tank to create microbubbles in the process liquid to thereby carry small particles to the surface, where they are removed by the flotate clearer; and
a pump for pumping the process liquid cleaned in the flotation tank back to the at least one heat exchanger.

14. The installation of claim 13, wherein the wheel separator comprises a plurality of rotatable shafts and a fixed lattice of closely spaced-apart strips, each shaft having a plurality of oval or elliptical plates secured thereto, the plates passing through the lattice when they rotate with the shafts, whereby the rotating plates are operable to move material from the process liquid on the lattice, while the process liquid moves through the lattice.
